(19) United States
(12) Patent Application Publication
(10) Pub. No.: US 2025/0198828 A1
(43) Pub. Date: Jun. 19, 2025

(54) GRAVIMETRIC METERING UNIT

(71) Applicant: K-TRON TECHNOLOGIES, INC., Sewell, NJ (US)

(72) Inventors: Men BERNEGGER, Zurich (CH); Rolf LEHMANN, Ammerswil (CH); Urs HELFENSTEIN, Seengen (CH)

(73) Assignee: K-TRON TECHNOLOGIES, INC., Sewell, NJ (US)

(21) Appl. No.: 18/709,698

(22) PCT Filed: Nov. 14, 2022
(86) PCT No.: PCT/IB2022/060929

§ 371 Date: Dec. 2, 2024

(30) Foreign Application Priority Data
Nov. 15, 2021 (CH) CH070559/2021

(51) Int. Cl. G01G 11/00; B65G 33/14; B65G 69/18

(52) U.S. Cl. CPC G01G 11/003; B65G 33/14; B65G 69/183

(57) ABSTRACT

A gravimetric metering unit for bulk material has a metering means having a container for bulk material to be metered and a base unit. The base unit has a conveyor channel that feeds into an outlet line of the metering unit via a connection device having a flexible sealing element. Via the connection device, the conveyor channel can be operationally connected to the outlet line and detached again from same. The connection device has a magnetic securing arrangement for the operational connection of the sealing element at least to either the outlet line or the conveyor channel or to both.

The present disclosure relates to a gravimetric metering unit for bulk material according to the preamble of claim 1.

Gravimetric metering means, also known as loss-in-weight-feeders, are widely used in many branches of industry for all kinds of flowable or bulk materials, i.e., bulk materials, as long as they can be conveyed by a gravimetric metering means at all. In this case, the bulk materials are dispensed into a container, from this into a base unit located below it, and from the metering means into an outlet channel by a conveyor located in the base unit. The metering means is located on a scale, so the weight registered by the scale is the gross weight, i.e., the known and constant weight of the metering means components (tare) plus the variable weight of the bulk material currently present in the container and in the base unit (net weight).

In this manner, the scale continuously registers the weight loss of the entire metering means during operation, and thus, due to the constant weight of the metering means, the weight loss of the bulk material present in the metering device, so that a controller of the metering means can determine the actual mass flow of the bulk material dispensed from the weight loss and, in comparison with a predetermined target mass flow, control the dispensing conveyor accordingly in order to minimize the difference between the actual and target mass flows.

Very precise control of the output mass flow may be necessary, such as in the area of pharmaceuticals or when color pigments are to be added in industrial manufacturing. In addition, the target mass flow can be small, e.g., for the color pigments mentioned and in the production of medicines (e.g., less than 1 kilogram per hour), or large, e.g., in the field of plastics production and mining (e.g., more than 1 t per hour), wherein precise metering may also be necessary for such conveying capacities. Furthermore, different batches can be run one after the other, wherein, in addition to regular maintenance, additional intensive cleaning may then be necessary, depending upon the bulk material.

As scales, all types of precise scales are often used, having a resolution over their weighing range of 1:100,000 and more, including those with vibrating wire sensors, such as those known for example as SFT-III, SFT-II-M, and SFT-II-L from Coperion K-Tron. These scales have a resolution of up to 1:4,000,000, so that precision metering can be carried out without any problems, even in the case of a container capacity of several hundred kilos and a delivery rate of several tons per hour. If a resolution of, for example, 1:1,000,000 is used, with a container capacity of 100 kg, the weight can still be recorded to an accuracy of 1/10 g and then used for metering.

In order to make the precision of the scales usable for metering, the connection to the outlet channel must be designed in such a way that no forces with components in the weight direction of the metering means are transferred from the outlet channel to the metering means, since otherwise the scales would measure such forces in addition to the actual weight loss, and the control would thus use an incorrect weight change of the metering means to regulate the actual mass flow.

Embodiments include non-vertical, i.e., horizontal or inclined, conveyors, as the fluid-dynamic behavior of the bulk material can be controlled somewhat better in this manner, as gravity does not act in the conveying direction, inter alia, in the case of horizontal conveyors, and thus does not influence the flow of the bulk material. For example, longer screw-conveyors are well suited as horizontal conveyors, as, when driven appropriately, the actual flow rate can be varied quite easily and without distortion via their rotational speed, and the distance from the mass flow from the funnel to a collecting container located outside the metering unit can be bridged well without any disadvantages in the actual mass flow itself. Often, such conveyors in a metering means of the type mentioned are clamped into a holder on an end shaft, wherein the holder supports the conveyor in a precisely aligned manner in its conveyor tube, which thus forms a conveyor channel.

For connecting the conveyor channel to the outlet line, a connection device is often provided, which has a flexible sealing element which, due to its mobility, allows relative movements between the conveyor channel (and thus the metering means) and the outlet line, thereby decoupling the metering means from forces resulting from this relative movement. These relative movements can be very small, depending upon the type of scale used, but are still relevant. Since the connection device must be suitable for the above-mentioned bulk materials, it is designed to be dust-tight, for example, i.e., it is usually connected to the conveyor channel and the outlet line via a screw connection having seals or via clamping rings. As mentioned above, when changing batches or when handling sensitive bulk materials, the flexible sealing element (and the entire connection device) must be cleaned or replaced.

If a plurality of metering units are grouped around a common outlet line in a spoke-like manner, as shown in the brochure, “K-Tron Product Information K4G Continuous Gravimetry Blender/K4G-L Group,” for example, in addition to the relatively high maintenance effort required due to the design, there are cramped conditions at the location of the outlet line, which are sometimes difficult for a fitter to access and thus increase the maintenance time, so that additional space for maintenance work often has to be provided when the metering unit is built.

Accordingly, it is the object of embodiments to provide a metering unit or a conveying arrangement for a metering means which saves maintenance time and can be easily assembled and disassembled even in confined spaces.

This object is achieved by a metering unit having the characterizing features of claim 1.

Since a magnetic connection is provided, the known detachable connections such as screw connections, etc., are no longer required, with the result that there is no space for the tool to be applied (and the necessary movements of the tool); in addition, the time for fastening and detaching the connections is eliminated, since a magnetic connection is ultimately a snap connection that can be released with a slight tug anywhere, also at the back of the metering means, and, when put back into position, snaps into place by itself.

Further embodiments have the features of the dependent claims.

Embodiments are described in slightly more detail below with reference to the figures.

In the figures:

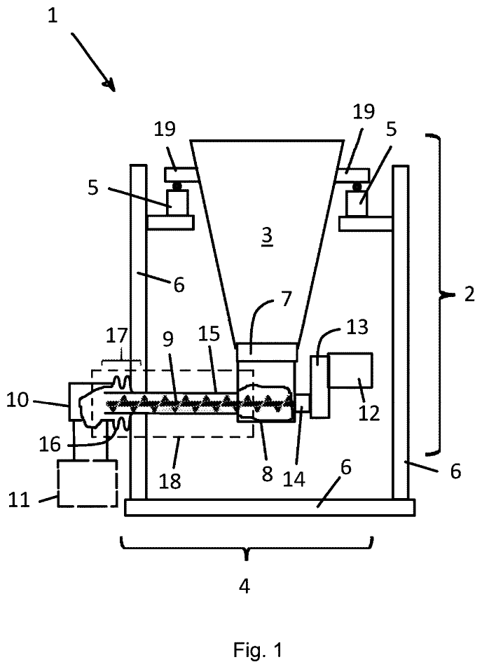

FIG. 1 is a schematic view of a metering unit of the prior art,

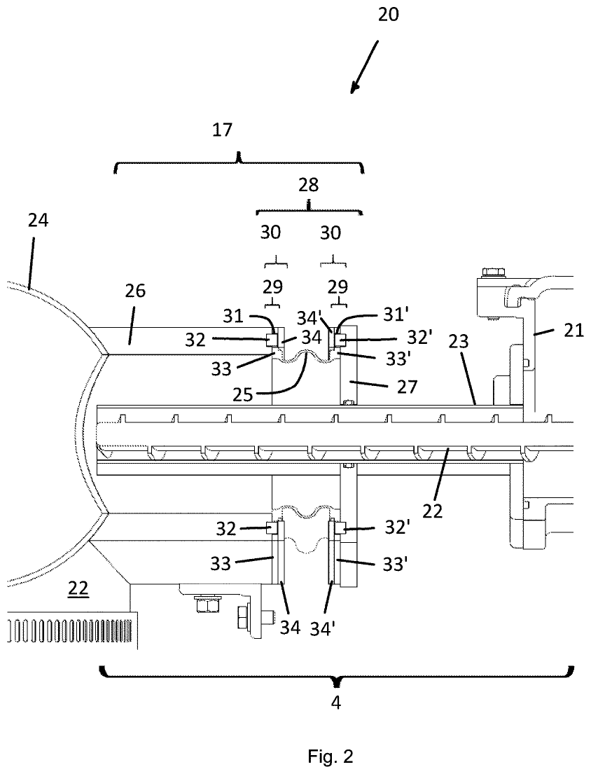

FIG. 2 shows an embodiment of a metering unit, and

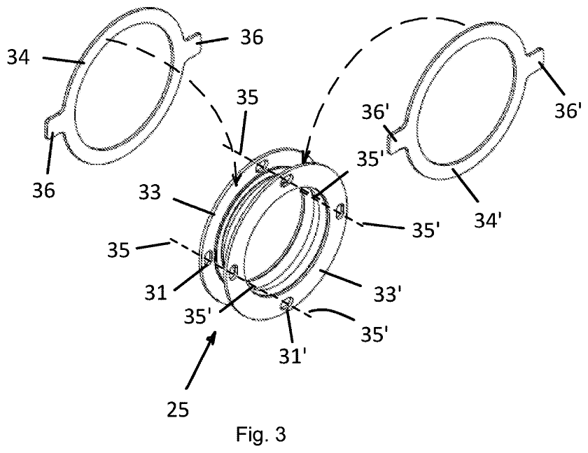

FIG. 3 is a view of the bellows having the fixing rings.

FIG. 1 is a schematic view of a gravimetric metering unit 1 of the prior art for bulk materials of the type mentioned above. In the metering unit 1, a metering means 2 having a funnel 3 and a base unit 4 is suspended above scales 5 in a frame 6.

During operation, the funnel 3 is filled with bulk material, which falls here via a transition funnel 7 (which can also be omitted) of the base unit 4 into a conveyor container 8, through which a screw-conveyor 9 protrudes, which conveys the bulk material from right to left into an outlet line 10, via which the bulk material reaches a further conveyor portion 11, indicated by dashed lines, for further processing. The funnel is refilled before it is empty.

In addition to the conveyor container 8, the base unit 4 comprises a drive motor 12 having a gear 13, the screw-conveyor 9 driven thereby, which in turn is attached to the mandrel of a holder 14 and extends after the conveyor container 8 through a conveyor channel 15, which also belongs to the base unit, to the outlet line 10. The base unit 4 or the conveyor channel 15 is mechanically decoupled from the outlet line 10 via a flexible sealing element, designed here as a bellows 17, which also seals completely for powdery bulk materials, so that the weighing of the metering unit 2 cannot be influenced by the outlet line 10. The bellows 17, together with the associated screw connection on the outlet line 10 and on the conveyor channel 15, forms a connection device 17 for connecting the conveyor channel 5 to the outlet line 10.

The metering means 2 rests on the scales 5 via supports 19, which thus register the weight of the metering means 2 and the weight of the bulk material in the funnel 3 (and in the base unit 4). If, during gravimetric operation of the metering unit 2, bulk material is discharged into the further conveyor portion 11 by the rotation of the screw-conveyor 9, its weight is reduced accordingly, which is registered by the scales 5 and in turn evaluated by a control system (not shown in order to reduce the complexity of the figure). The weight reduction corresponds to the actual mass flow of bulk material output, which must be adjusted to the target mass flow. For this purpose, the control system continuously corrects the speed of the screw-conveyor 9 via the drive motor 12 in accordance with a control algorithm that is generally known to a person skilled in the art.

If, for example, a plurality of metering units 1 are grouped around the common outlet line 10, the maintenance or cleaning of the bellows 16 must be carried out from the right-hand side, past the motor 12, the conveyor container 8, and the conveyor channel 15, which is laborious and, above all, makes the use of tools difficult, especially if the space at the location of the bellows 16 is limited.

FIG. 2 shows a view of a part of the base unit 20 of a metering unit, which corresponds to the dashed region 18 of the metering unit 1 of FIG. 1. In this case, one third of the components shown are cut away, so that their upper half is shown in cross-section (the cutting plane lies in the drawing plane) and their lower half in a diagonal section running from below, so that the cutting plane is inclined at about 30 degrees to the drawing plane.

A conveyor container 21 is visible, through which a screw-conveyor 22 protrudes, which extends further to the left after the conveyor container 21 through a conveyor channel 23 to an outlet line 24, into which it in turn protrudes freely suspended and thus without contact. During operation, the conveyed bulk material passes from the conveyor container 21 via the rotating screw-conveyor 22 to the left into the outlet line 24, where it falls downwards into the further conveyor portion 11 (FIG. 1), not shown in FIG. 2.

In embodiments, the connection device 17 has a flexible sealing element, which, in the embodiment shown, is designed as a bellows 25, as well as a connection piece 26 and a carrier 27 for the bellows 25. Instead of a bellows, a person skilled in the art can also provide another suitable flexible connection in the specific case; instead of a separate carrier 27, e.g., in the case of a short conveyor channel, the wall of the conveyor container 21 (or another component of the metering means 2 of FIG. 1) can also be designed as a carrier. Likewise, for example, the connection piece can be formed by the outlet line 24 itself, depending upon the design of the base unit 4 in the specific case.

It should be noted at this point that FIG. 2 also shows that, in one embodiment, the conveyor channel 23 is arranged horizontally. FIG. 2 also shows how the conveyor channel 23 projects in the conveying direction (i.e., in the figure from right to left towards the outlet line 24) over the bellows 25 or the flexible sealing element, so that bulk material discharged from it falls directly into the outlet line 24, possibly also into the connector 26, but not into or onto the bellows 25. Bulk material falling onto the bellows 25 would load it by the impact and the weight of its mass, wherein these forces would necessarily also act upon the carrier 27 supporting the bellows 25, with the result that the scales 5 (FIG. 1) would register additional weight which would falsify the metering of the bulk material. The connection device 17 is thus designed in such a way that dispensed bulk material cannot impair the weight measurement by the scales 5 and thus the gravimetric metering of the bulk material. In embodiments, the end, facing the outlet line (24), of the sealing element is thus located in the conveying direction at or behind the end, facing the outlet line (24), of the conveyor channel (23), such that the bulk material flow discharged from the conveyor channel (23) during operation does not reach the sealing element.

A magnetic securing arrangement 28 provided in the connection device 17 ensures the detachable and reconnectable connection of the flexible sealing element or bellows 25 with, on the one hand, the outlet line 24 (via the outlet connector 26) and, on the other, the conveyor channel 23 (via the carrier 27). The magnetic securing arrangement 28 now has, on the one hand, a mechanical positioning arrangement 29 for the mechanical positioning of the bellows 25 in the connection device 17 in its operating position and, on the other, a magnetic fixing arrangement 30 for magnetically fixing the bellows 25 in its (mechanically specified) operating position.

The mechanical positioning arrangement 29 has stop elements on the bellows 25 and diametrically opposed stop elements on the outlet connector 26 and on the carrier 27. In the embodiment shown, the stop elements on the bellows 25 are designed as openings 31, 31′, the diametrically opposed stop elements as magnets having the geometric shape of positioning pins (the magnetic property being irrelevant for the mechanical position arrangement), so that the diametrically opposed stop elements here are positioning magnets 32, 32′, which are arranged on the outlet connector 26 and on the carrier 27 and mechanically engage in the openings 31, 31′.

The openings 31, 31′ are located in securing portions of the bellows 25
here, in a radially projecting flange 33, 33′. However, the securing portions can also be designed as tongues having openings and suitably arranged on the flexible sealing element, but other suitable regions of the flexible sealing element can also be provided as securing portions. It is apparent that the flexible sealing element has securing portions having openings for positioning pins. It further follows that the securing portions are, in embodiments, designed as a flange projecting radially from the bellows, wherein a flange is provided at least at one end or at both ends of the bellows. FIG. 3 shows the bellows 25 of FIG. 2 in detail.

It also follows that, in embodiments, the mechanical positioning arrangement 29 has stop elements on the flexible sealing element and further stop elements that are diametrically opposed to the stop elements on a connection piece 26, arranged on the outlet line, or on a carrier 27 arranged on the base unit 4, which determine the operative relative position of the flexible sealing element on the connection piece 26 or on the carrier 27.

It should be noted at this point that “diametrically opposed” does not necessarily mean complete congruence of the interacting stop surfaces. From FIG. 2 it can be seen, for example, that the positioning magnets 32, 32′ position the bellows 25 precisely radially, while the exact angular position of the bellows is less critical. Accordingly, the openings 31, 31′ can also be designed as slots, since the ferromagnetic ring 34, 34′ adheres equally well to the positioning magnets 32, 32′ in any angular position. “Diametrically opposed” thus means a completely identical (congruent) design of the stop surfaces, or at least to the extent that is necessary for perfect operational positioning depending upon the specific design of the magnetic securing arrangement 28.

In addition to the positioning magnets 32, 32′, which are each arranged in the connection piece 26 and in the carrier 27, e.g., glued in, the magnetic fixing arrangement 30 has a magnetic ring 34, 34′ in each case, which is designed, for example, as a ferromagnetic ring and magnetically interacts with the positioning magnets 32, 32′. However, the ring 34, 34′ can also consist of a plastic equipped with magnets, or another non-magnetic material. In the embodiment shown in FIG. 2, the positioning magnets 32, 32′ have a mechanical function (positioning; see above) and a magnetic function in that they attract the magnetic ring 34, 34′ and thus fix it in its position.

As a result, each ring 33, 33′ held in place by the magnets 32, 32′ encloses a flange 34, 34′ of the bellows 25 between itself and the connecting piece 26 or the carrier 27, so that the bellows 25 cannot be lifted off the connecting piece 26 or the carrier 27, thus fixing the flange 34, 34′ and thus the bellows 25 in its relative position (defined by the stop elements) to these in an operative manner. In this description, operational means that the intended function can be maintained under all conditions occurring during operation of the metering unit, such as movements or bulk materials used, etc. Thus, the ring 34, regardless of its specific design, represents a magnetically effective fixing element which can be designed as a fixing ring or in another suitable form. FIG. 3 shows the bellows 25 and the magnetic rings 34 of FIG. 2 in detail.

With the ferromagnetic rings 34, 34′, a magnetic effective region is present on the bellows 25, and, with the positioning magnets 32, 32′, a magnetic effective region is arranged diametrically opposed on the outlet connector 26 or carrier 27, wherein these magnetic effective regions interact.

It follows that, in embodiments, the magnetic fixing arrangement 30 has a magnetic effective region on the flexible sealing element (here designed as a bellows) and a magnetic effective region, arranged diametrically opposed (in terms of its position), on a connection piece 26, arranged on the outlet line 24, or on a carrier 27 arranged on the base unit 4, which effective regions operatively fix the operative relative position of the flexible sealing element on the connection piece 26 or on the carrier 27.

In the embodiment shown in FIG. 2, the positioning magnets 32, 32′ act on the one hand as stops for the openings 31, 31′, and on the other as magnets that fix the magnetic ring 34, 34′. It is apparent that, in embodiments, the one magnetic effective region is formed by positioning pins designed as magnets—in the embodiment according to FIG. 2, by the positioning magnets 32, 32′.

FIG. 3 is an exploded view of the bellows 25 and the magnetic rings 34, 34′, wherein the connecting piece 26 and the carrier 27 (FIG. 2) are omitted to reduce the complexity of the figure, but the position of the positioning magnets 32, 32′ (FIG. 2) is indicated by the dashed lines 35, 35′. In the assembled state, the ring 34 lies on the inside of the flange 33, and the ring 34′ lies on the inside of the flange 33′, as indicated by the dashed arrows. Each ring 34, 34′ has handles 36, 36′ in embodiments. It follows that the fixing element, designed here as a fixing ring (34, 34′), in embodiments has handles (36) and is, in embodiments, ferromagnetic. However, as mentioned above, it can also be made of a non-magnetic material, for example, and contain magnets or ferromagnetic material.

This allows the fitter to simply pull out a metering unit 1, assembled in an operationally ready state with a base unit 4 designed, for example, as shown in FIG. 2, to the right with a slight jerk, wherein the magnetic connection between the outlet line 24 and the conveyor channel 23 are released, even in confined spaces, without the use of tools or work and without any expenditure of time.

If the dismantled base unit 4 is to be reconnected to the outlet line 26, the bellows 25 can simply be pushed onto the positioning magnets 32′ on the carrier 27, and the ring 34 can be placed on them, whereby the bellows are fixed in the correct position on the carrier 27. The base unit 4 is then brought into the operational position along its length from right to left, whereupon the fitter can simply reach behind the conveyor container 21 against the connecting piece 26 and there grasp the loose ring 34 by the handles 36 between the thumb and fingers and place it on the connecting piece 26; the openings 31 are already located at the location of the positioning magnets 32, since the flange 34′ is already correctly positioned by the positioning magnets 32′. There is no need for tools; this manipulation requires comparatively little space, and therefore the limited space is not an issue. The time required is also negligible.

In a further embodiment not shown in the figures, the bellows 25 or the flexible sealing element is provided with a magnetic securing arrangement on only one side, while the other side is conventionally fastened to the connecting piece or to the carrier. It is then advantageous that the base unit 4 can be detached (or mounted) as described, wherein the conventional securing to the removed base unit 4 can then be detached or connected more easily and more quickly. Conversely, if the conventional securing is on the side of the connection piece, the flexible sealing element can also be dismantled or assembled more easily, since the dismantled base unit is no longer in the way, and therefore the space is less cramped.

In a further embodiment not shown in the figures, the mechanical positioning arrangement and the magnetic fixing arrangement are separated from each other, so that the stop elements are not magnetically effective.

In embodiments, however, as in the case of the positioning magnets 32, 32′, the stop elements then have positioning pins, and the diametrically opposed stop elements have openings that are diametrically opposed to the positioning pins, and, further, in embodiments, the stop elements have openings provided in the flexible sealing element, and the diametrically opposed stop elements have positioning pins that are fixed relative to the connection piece 26 or the carrier 27.

Regardless of whether the mechanical position arrangement and the magnetic fixing arrangement are separate from one another, in embodiments, the flexible sealing element has securing portions, and the magnetic effective region on the flexible sealing element is formed by at least one magnetic fixing element which, in the operating position, encloses the securing portions between itself and either the connecting piece or the carrier, and thus operatively fixes the flexible sealing element in an operative position, wherein the fixing element in turn is held magnetically in its position.

In the embodiment shown in FIG. 2, the positioning pins designed as magnets are arranged at least either on the connecting piece 26 or on the carrier 27 or on both, extend from one side through the openings 31, 31′, provided on the flexible sealing element, for the positioning pins, and, further, on the other side of the openings 31, 31′, at least one magnetic fixing element is provided, which encloses the securing portions of the flexible sealing element between itself and the connecting piece 26 or between itself and the carrier 27 and, magnetically fixed to the magnet, in turn fixes the flexible sealing element in an operative bearing.

Not shown in the figures is an embodiment in which, instead of the connecting piece 26 or the carrier 27, the fixing ring or the fixing element has the magnetic positioning pins, and then, for example, the connecting piece 26 or carrier 27 consists of a ferromagnetic material and has openings for the positioning pins.

In embodiments, the positioning pins designed as magnets are arranged on the fixing element and extend from one side through the openings for the positioning pins, provided on the flexible sealing element, and, further, on the other side, magnetically effective openings are provided in the connection piece or the carrier, wherein the fixing element encloses the securing portions of the flexible sealing element between itself and the connection piece or the carrier and, magnetically fixed to the openings, in turn fixes the flexible sealing element in an operative position.

The situation is different if, as mentioned above, the mechanical positioning arrangement and the magnetic fixing arrangement are separated from each other, so that the stop elements are not magnetically effective. Then, for example, magnets can be arranged on the connecting piece 26 or on the carrier 27 separately from the stop elements, which magnets interact with a ferromagnetic fixing ring or fixing element which is in turn equipped with magnets. The connecting piece 26 or the carrier 27 are ferromagnetic and interact with magnets arranged on the fixing element.

It follows that, in embodiments, the magnetic fixing arrangement has magnets which are separate from the mechanical position arrangement and which are arranged in the connecting piece or in the carrier, and the fixing element is designed to be magnetically effective, wherein this encloses the securing portions of the flexible sealing element between itself and the connecting piece or between itself and the carrier and, magnetically fixed to the magnet, in turn fixes the flexible sealing element in an operative bearing.

Common to all described embodiments is a gravimetric metering unit for bulk materials, which has a metering means 2 having a container 8 for bulk material to be metered and having a base unit 4, wherein the base unit 4 has a conveying channel which opens into an outlet line of the metering unit 1 via a connection device having a flexible sealing element, and wherein the conveyor channel can be operatively connected to the outlet line and detached from it again via the connection device, wherein the connection device further has a magnetic securing arrangement for the operative connection of the sealing element at least to either the outlet line or the conveyor channel or to both.

1. A gravimetric metering unit for bulk material, having a metering means having a container for bulk material to be metered and a base unit, wherein the base unit has a conveyor channel that feeds into an outlet line of the metering unit via a connection device having a flexible sealing element, and wherein the conveyor channel can be operationally connected to the outlet line and detached again therefrom via the connection device,
wherein the connection device has a magnetic securing arrangement for the operational connection of the sealing element at least to either the outlet line or the conveyor channel or to both.

2. The gravimetric metering unit according to claim 1, wherein the magnetic securing arrangement has a mechanical positioning arrangement for positioning the flexible sealing element in the connection device in its operating position and a magnetic fixing arrangement for magnetically fixing the flexible sealing element in the operating position.

3. The gravimetric metering unit according to claim 1, wherein the mechanical positioning arrangement has stop elements on the flexible sealing element and further stop elements which are designed to be diametrically opposed to the stop elements on a connection piece, arranged on the outlet line, or on a carrier arranged on the base unit, which determine the operative relative position of the flexible sealing element on the connection piece or on the carrier.

4. The gravimetric metering unit according to claim 3, wherein the stop elements have positioning pins, and the stop elements which are designed to be diametrically opposed have openings which are designed to be diametrically opposed to the positioning pins.

5. The gravimetric metering unit according to claim 3, wherein the stop elements have openings provided in the flexible sealing element, and the diametrically opposed stop elements have positioning pins which are fixed relative to the connection piece or the carrier.

6. The gravimetric metering unit according to claim 4, wherein the flexible sealing element has securing portions having openings for positioning pins.

7. The gravimetric metering unit according to claim 1, wherein the flexible sealing element is designed as a bellows.

8. The gravimetric metering unit according to claim 6, wherein the flexible sealing element is designed as a bellows, wherein the securing portions are designed as a flange projecting radially from the bellows, wherein a flange is provided at least at one end or at both ends of the bellows.

9. The gravimetric metering unit according to claim 2, wherein the magnetic fixing arrangement has a magnetic effective region on the flexible sealing element and, arranged diametrically opposed, a magnetic effective region on a connection piece, arranged on the outlet line, or on a carrier arranged on the base unit, which effective regions operatively fix the operative relative position of the flexible sealing element on the connection piece or on the carrier.

10. The gravimetric metering unit according to claim 9, wherein the flexible sealing element has securing portions, and the magnetic effective region on the flexible sealing element is formed by at least one magnetic fixing element which, in the operating position, encloses the securing portions between itself and either the connection piece or the carrier and thus operatively fixes the flexible sealing element in an operative position, wherein the fixing element in turn is held magnetically in its position.

11. The gravimetric metering unit according to claim 9, wherein the one magnetic effective region is formed by positioning pins designed as magnets.

12. The gravimetric metering unit according to claim 6, wherein the magnetic securing arrangement has a mechanical positioning arrangement for positioning the flexible sealing element in the connection device in its operating position and a magnetic fixing arrangement for magnetically fixing the flexible sealing element in the operating position, wherein the magnetic fixing arrangement has a magnetic effective region on the flexible sealing element and, arranged diametrically opposed, a magnetic effective region on a connection piece, arranged on the outlet line, or on a carrier arranged on the base unit, which effective regions operatively fix the operative relative position of the flexible sealing element on the connection piece or on the carrier, wherein the one magnetic effective region is formed by positioning pins designed as magnets, wherein the positioning pins designed as magnets are arranged at least either on the connection piece or on the carrier or on both, extend from one side through the openings provided on the flexible sealing element for the positioning pins, and, further, on the other side of the openings, at least one magnetic fixing element is provided, which encloses the securing portions of the flexible sealing element between itself and the connecting piece or between itself and the carrier and, magnetically fixed to the magnet, in turn fixes the flexible sealing element in an operative bearing.

13. The gravimetric metering unit according to claim 6, wherein the magnetic securing arrangement has a mechanical positioning arrangement for positioning the flexible sealing element in the connection device in its operating position and a magnetic fixing arrangement for magnetically fixing the flexible sealing element in the operating position, wherein the magnetic fixing arrangement has a magnetic effective region on the flexible sealing element and, arranged diametrically opposed, a magnetic effective region on a connection piece, arranged on the outlet line, or on a carrier arranged on the base unit, which effective regions operatively fix the operative relative position of the flexible sealing element on the connection piece or on the carrier, wherein the one magnetic effective region is formed by positioning pins designed as magnets, wherein the positioning pins designed as magnets are arranged on the fixing element and extend from one side through the openings for the positioning pins provided on the flexible sealing element, and, further, on the other side, magnetically effective openings are provided in the connection piece or the carrier, wherein the fixing element encloses the securing portions of the flexible sealing element between itself and the connection piece or the carrier and, magnetically fixed to the openings, in turn fixes the flexible sealing element in an operative bearing.

14. The gravimetric metering unit according to claim 3, wherein the magnetic fixing arrangement has magnets which are separate from the mechanical positioning arrangement and are arranged in the connection piece or in the carrier, and the fixing element is designed to be magnetically effective, and wherein said fixing element encloses the securing portions of the flexible sealing element between itself and the connection piece or between itself and the carrier and, magnetically fixed to the magnet, in turn fixes the flexible sealing element in an operative bearing.

15. The gravimetric metering unit according to claim 10, wherein the magnetic fixing element is designed as a ferromagnetic ring.

16. The gravimetric metering unit according to claim 10, wherein the fixing element has magnets.

17. The gravimetric metering unit according to claim 10, wherein the fixing element has handles.

18. The gravimetric metering unit according to claim 1, wherein the conveying channel is arranged horizontally.

19. The gravimetric metering unit according to claim 1, wherein the end, facing the outlet line, of the sealing element is located in the conveying direction at or behind the end, facing the outlet line, of the conveying channel, such that the bulk material flow output from the conveying channel during operation does not reach the sealing element.
